(19) United States
(12) Patent Application Publication
(10) Pub. No.: US 2022/0240529 A1
(43) Pub. Date: Aug. 4, 2022

(54) COMPOSITION COMPRISING LACTOCOCCUS, METHODS AND PRODUCTS THEREOF

(71) Applicant: Chr. Hansen A/S, Hoersholm (DK)

(72) Inventors: Thomas ECKHARDT, Hoersholm (DK); Jannik VINDELOEV, Hoersholm (DK); Kristian Fog NIELSEN, Hoersholm (DK); Gunnar OEREGAARD, Hoersholm (DK)

(73) Assignee: Chr. Hansen A/S, Hoersholm (DK)

(21) Appl. No.: 17/614,986

(22) PCT Filed: Jun. 2, 2020
(86) PCT No.: PCT/EP2020/065168

§ 371 Date: Nov. 29, 2021

(30) Foreign Application Priority Data
May 31, 2019 (EP) 19177678.0

(51) Int. Cl. A23C 19/032; A23C 19/09; A23C 19/10

(52) U.S. Cl. CPC A23C 19/0323; A23C 19/10; A23C 19/0921

(57) ABSTRACT

The present invention relates to Lactococcus starter cultures that are compatible with nisin-producing strains and simultaneously do not degrade nisin. The present invention defines starter cultures that can be used in combination with nisin-producing cultures, without degradation of nisin. Furthermore, it is also disclosed that starter cultures can be made by a combination of nisin-producing strains and strains containing nisin-immunity genes and/or and absent of the gene to prevent degradation of nisin.

### FIELD OF THE INVENTION

The present invention relates to Lactococcus starter cultures that are compatible with nisin-producing strains and simultaneously do not degrade nisin. Furthermore, the present invention also discloses that starter cultures can be made by a combination of nisin-producing strains (nisA+strain, nis Z+strain or nisQ+strain), non-nisin degrading strains (nsr− strains) and nisin-immune strains (nisI+ and/or nisFEG+ strains), such that degradation of nisin is prevented, while simultaneously the strains of the composition now disclosed are not negatively affected by the presence of nisin.

### BACKGROUND OF THE INVENTION

A major problem in the cheese industry is spoilage by unwanted Clostridium strains.

Nisin is an anti-microbial peptide, also known as a bacteriocin, that is synthesized by Lactococcus strains containing the nis operon. Nisin-producing strains may be used for the suppression of Clostridium growth in cheese. However, when used together with a starter culture, nisin-producing strains may inhibit nisin-sensitive strains and change the strain balance in the starter culture. This in turn may delay or prevent acidification, reduce phage robustness and change flavor properties of the culture, preventing the starter culture to perform as intended.

On the other hand, strains may exist in the starter culture that will compete with or even fight the nisin-producing strains or, most importantly for this invention, degrade the nisin produced, thereby preventing the nisin producing strains to perform as intended.

The patent document EP1273237 describes the use of nisin-producing strains in fermented food products. The strategy employed was to immunize Gram-positive strains, by stepwise increasing the nisin concentration in the growth medium (nisin adaptation). The use of making conjugants by plasmid transfer of Tn5276, thereby immunizing Gram-positive strains against nisin, is also described. However, this strategy is time-consuming and does not prevent that a nisin-degrading strain is chosen for the composition of the starter culture, thereby leading to degradation of nisin and reduction of effect of nisin in avoiding spoilage of cheese by unwanted Clostridium strains.

The patent document EP2165608 describes using nisin-intolerant bulk starter and nisin-producing direct vat set culture to inoculate cheese milk for flavor development. Such nisin-intolerant bulk starter, when added to pasteurized milk at about 1 wt. % with respect to the weight of the milk, in the presence of nisin at 10 units/ml or more, is incapable of reducing the pH of the milk by at least 1 pH unit during incubation of the milk for 6 hours at a temperature of 30° C. In other words, EP2165608 makes use of bulk starter cultures which are not able to grow well in the presence of nisin.

The patent document WO9616180 describes methods to modify cells so to produce nisA variant. It was found that the production is higher compared to the natural nisA level. To ensure that the cells are viable in a higher level of nisin, nisin adaptation to at least to a level of 1000 U/ml can be carried out to select cells which are immune to nisin. This document thus discloses providing nisin A variant-producing strain which is immune to nisin.

### Nisin Variants

Nisin is a lantibiotic known to be a heat-stable, acid-tolerant, small peptide with heavy post-translational modifications possessing an antimicrobial activity against Gram-positive bacteria (Gross and Morell, 1971). Nisin is on the market for years as an effective agent against undesired Clostridium contaminations in cheese-making (Delves-Broughton et al., 1996). Nisin can bind to lipid II, an intermediate essential for cell wall elongation (Hasper et al., 2004). Not only cell division is hindered upon nisin binding to lipid II, but pores are created in the Gram-positive cell-wall when concentrations of nisin are high enough to create a nisin octomer.

Natural variants of nisin occur in Lactococcus strains from different isolation sources. Nisin A and Nisin Z are the most common ones, found in many dairy isolates. These two nisin variants share the same structure except for an amino acid at position 27. The following nisin variants are also known and described: nisin Q, nisin U, nisin U2, nisin P, nisin F and nisin H (O'Connor et al., 2015). Nisin Q has four amino acid substitutions when comparing to nisin A at the C-terminal part of the molecule (Zendo et al., 2003). Antimicrobial activity assays reveal only small differences between the three nisin variants against different target organisms (Yoneyama et al., 2008). Nisin-recognition by nisin RK seems to be lower for nisin Q, thus reducing the auto-stimulatory loop effect which has been so powerful for nisin variants A and Z (Kuipers et al., 1998; Chandrapati et al., 2002). It is also suggested that nisin Q has a higher oxidative tolerance due to a M21L substitution, giving it a stability advantage at low pH or during freeze drying (Yoneyama et al., 2008).

### Nisin Degradation

Nisin degradation (NSR) is a direct cleavage of the active molecule. Lactococcal NSR (LaNSR) has been shown to cleave the peptide bond between Melan28 and S29, thereby inactivating the nisin Z peptide (Froseth et al., 1991; Sun et al., 2009). The more efficient NSR system of Streptococcus agalactiaea (SaNSR) is located between a collaborating lantibiotic immunity system consisting of an ABC-transporter (NSRABC) and a two-component signaling system (NSRFP) (Khosa et al., 2013). When nisin is recognized by the NSRFP system, it induces the expression of the SaNSR protease. Even though SaNSR is different in size to LaNSR, it cleaves nisin in a very similar fashion at the same amino acid position. For S. agalactiaea strains having the combination of the immunity by NSRABC and the protease SaNSR is what gives a high level of protection against nisin (Khosa et al., 2016).

Thus, a nisin-degrading strain may be defined as a strain that can acidify milk when exposed to nisin since it is able to enzymatically degrade nisin. This strain may have a nsr⁺ genotype (Sun et al. 2009). Furthermore, the milk acidification by a nsr⁺ genotype strain is often delayed because of the time that said strain needs to produce the nisin degradation enzyme and effectively degrade nisin.

In contrast, a non-nisin degrading strain is unable to inactivate nisin by directly cleaving the peptide bond as mentioned above. This can be determined by methods known to a skilled person in the art or by methods described in the present application (such as in Example 2).

### Nisin Immunity

Immunity against nisin can be obtained in Lactococcus (L.) lactis via actively transporting cell-associated nisin into the extracellular space with lipoprotein Nisl and ABC transporter NisFEG (Stein et al., 2003). Once nisin has started making pores, Nisl and NisFEG cannot fully remove the peptides, making it difficult to obtain complete immunity against nisin (Stein et al., 2003). Transporters can efflux nanomolar concentrations of small antimicrobial peptides in the cell wall of different organisms, like the cprABCK-R system in Clostridium difficile, the nsrFE₁E₂G-XRK and IcrSR-IctFEG from S. mutans, all very similar to the nisRK-FEG system in L. lactis (Clemens et al.,2018; Reiners et al., 2017). The resemblance between these systems is that they are all based on a two-component system (CprRK; NsrRK; LcrSR and NisRK respectively). This membrane-protein complex recognizes the lantibiotic and regulates the other genes such as the ABC-transporter (CprABC; NsrFE₁E₂G; LctFEG and NisFEG respectively) and the other lipoproteins (NisI) or specific membrane-associated proteases (NSR) which can give protection against some lantibiotics.

Hence, a nisin-immune strain may be defined as a strain that is able to acidify milk and that has similar acidification curves independently of the presence or absence of nisin. Thus, for these strains, the lag-time and the slope of the milk acidification curves are similar in the presence or absence of nisin. The genotype of said strain may be nisI⁺ or nisFEG⁺ or nisIFEG⁺. The nisin-immune strain may be further a strain that does not degrade nisin, being therefore a nsr⁻ strain. Then a nisin-immune strain can also have a nsr⁻nisI⁺ genotype or a nsrnisFEG⁺ genotype or a nsrnisIFEG⁺ genotype.

### Nisin Sensitivity

A nisin-sensitive strain may be defined as a strain that cannot acidify milk when exposed to nisin. This strain has a nsr− and nisIFEG− genotype.

### SUMMARY OF THE INVENTION

The objective of the present invention is to provide a composition capable of preventing spoilage of food products, such as cheese, by unwanted Clostridium strains. The objective is achieved by providing a composition wherein strains are selected such that nisin can be produced without being degraded while simultaneously the acidification of milk is not delayed or preventing.

Thus, in a first aspect, the present invention relates to a composition comprising:
a nisin-producing strain of Lactococcus,
a non-nisin degrading strain of Lactococcus, and
a nisin-immune strain of Lactococcus
wherein the nisin-producing strain of Lactococcus and the non-nisin degrading strain of Lactococcus are different from each other and the non-nisin degrading strain of Lactococcus and the nisin-immune strain of Lactococcus is the same strain or

wherein the nisin-producing strain of Lactococcus, the non-nisin degrading strain of Lactococcus and the nisin-immune strain of Lactococcus is the same strain. In one embodiment, the nisin-producing strain of Lactococcus is Lactococcus lactis, preferably Lactococcus lactis subsp. lactis, Lactococcus lactis subsp. lactis biovar diacetylactis, or Lactococcus lactis subsp. cremoris.

In one embodiment, the non-nisin degrading strain of Lactococcus is Lactococcus lactis, preferably Lactococcus lactis subsp. lactis, Lactococcus lactis subsp. lactis biovar diacetylactis, or Lactococcus lactis subsp. cremoris.

In one embodiment, the nisin-immune strain of Lactococcus is Lactococcus lactis, preferably Lactococcus lactis subsp. lactis, Lactococcus lactis subsp. lactis biovar diacetylactis, or Lactococcus lactis subsp. cremoris.

In one embodiment, the nisin-producing strain of Lactococcus, the non-nisin degrading strain of Lactococcus and the nisin-immune strain of Lactococcus is the same strain and is Lactococcus lactis, preferably Lactococcus lactis subsp. lactis, Lactococcus lactis subsp. lactis biovar diacetylactis, or Lactococcus lactis subsp. cremoris.

In an embodiment, the nisin-producing strain of Lactococcus, preferably Lactococcus lactis, may comprise a sequence having at least 95%, 96%, 97%, 98%, 99% or 100% sequence identity with SEQ ID NO: 1 (nisA), or may comprise a sequence having at least 95%, 96%, 97%, 98%, 99% or 100% sequence identity with SEQ ID NO: 2 (nisZ), or may comprise a sequence having at least 95%, 96%, 97%, 98%, 99% or 100% sequence identity with or SEQ ID NO: 3 (nisQ).

In an embodiment, the nisin-producing strain of Lactococcus, preferably Lactococcus lactis, may also comprise a sequence having at least at least 90%, 95%, 96%, 97%, 98%, 99% or 100% sequence identity with SEQ ID NO: 6 (nisBCTPRK).

In an embodiment, the nisin-producing strain of Lactococcus, preferably Lactococcus lactis, may produce at least 1 mg nisin/kg cheese. The nisin quantification per kg of cheese can be done by standard techniques such as liquid chromatography coupled to tandem mass spectrometry with electrospray ionization (LC-MS/MS) as described in ISO/TS 27106:2009″.

In an embodiment, the non-nisin degrading strain of Lactococcus, preferably Lactococcus lactis, is free of a sequence having at least 90% 95%, 96%, 97%, 98%, 99% or 100% sequence identity with SEQ ID NO: 7 or 8 (nsr−). SEQ ID NO. 7 encodes the C-terminus of the lactococcal NSR, which serves as a proxy for lactococcal NSR. The Uniprot P23648 sequence as set forth in SEQ ID NO: 8 encodes the full length of the lactococcal NSR.

In a preferred embodiment, the non-nisin degrading strain of Lactococcus is a nisin-immune strain of Lactococcus. Preferably, the non-nisin degrading strain of Lactococcus comprises a sequence having at least 95%, 96%, 97%, 98%, 99% or 100% sequence identity with SEQ ID NO: 4 (nisI), or comprises a sequence having at least 95%, 96%, 97%, 98%, 99% or 100% sequence identity with SEQ ID NO: 5 (nisFEG), or comprises two sequences, a first sequence having at least 95%, 96%, 97%, 98%, 99% or 100% sequence identity with SEQ ID NO: 4 (nisI) and a second sequence having at least 95%, 96%, 97%, 98%, 99% or 100% sequence identity with SEQ ID NO: 5 (nisFEG).

In a preferred embodiment, the non-nisin degrading strain of Lactococcus is free of a sequence having at least 90% 95%, 96%, 97%, 98%, 99% or 100% sequence identity with SEQ ID NO: 7 or 8 (nsr−) and comprises a sequence having at least 95%, 96%, 97%, 98%, 99% or 100% sequence identity with SEQ ID NO: 4 (nisI).

In another preferred embodiment, the non-nisin degrading strain of Lactococcus is free of a sequence having at least 90% 95%, 96%, 97%, 98%, 99% or 100% sequence identity with SEQ ID NO: 7 or 8 (nsr−) and comprises a sequence having at least 95%, 96%, 97%, 98%, 99% or 100% sequence identity with SEQ ID NO: 5 (nisFEG).

In yet another preferred embodiment, the non-nisin degrading strain of Lactococcus is free of a sequence having at least 90% 95%, 96%, 97%, 98%, 99% or 100% sequence identity with SEQ ID NO: 7 or 8 (nsr−) and comprises a sequence having at least 95%, 96%, 97%, 98%, 99% or 100% sequence identity with SEQ ID NO: 4 (nisI) and a sequence having at least 95%, 96%, 97%, 98%, 99% or 100% sequence identity with SEQ ID NO: 5 (nisFEG).

The composition now disclosed may further comprise a non-nisin degrading strain of Lactococcus, and a non-nisin immune strain of Lactococcus, wherein the non-nisin degrading strain of Lactococcus, and non-nisin immune strain of Lactococcus is the same strain. This composition leads to the control of the flavor properties of the culture and of the final food product, such as cheese. Furthermore, this composition may also improve phage robustness.

In an embodiment, the composition now disclosed may further comprise
a non-nisin degrading strain of Lactococcus free of a sequence having at least 90% 95%, 96%, 97%, 98%, 99% or 100% sequence identity with SEQ ID NO: 7 or 8 (nsr-) and free of a sequence having at least 90% 95%, 96%, 97%, 98%, 99% or 100% sequence identity with SEQ ID NO: 4 (nisI−) or
a non-nisin degrading strain of Lactococcus free of a sequence having at least 90% 95%, 96%, 97%, 98%, 99% or 100% sequence identity with SEQ ID NO: 7 or 8 (nsr−) and is free of a sequence having at least 90% 95%, 96%, 97%, 98%, 99% or 100% sequence identity with SEQ ID NO: 5 (nisFEG−) or
a non-nisin degrading strain of Lactococcus free of a sequence having at least 90% 95%, 96%, 97%, 98%, 99% or 100% sequence identity with SEQ ID NO: 7 or 8 (nsr−), is free of a sequence having at least 90% 95%, 96%, 97%, 98%, 99% or 100% sequence identity with SEQ ID NO: 4 (nisI−) and free of a sequence having at least 90% 95%, 96%, 97%, 98%, 99% or 100% sequence identity with SEQ ID NO: 5 (nisFEG−).

In an embodiment, the composition now disclosed may further nisin, preferably may further comprise at least 1 mg nisin/kg cheese wherein nisin is nisin A and/or nisin Z.

Lactic acid bacteria, including bacteria of the species Lactococcus, are normally supplied to the dairy industry either as frozen or freeze-dried cultures for bulk starter propagation or as so-called “Direct Vat Set” (DVS) cultures, intended for direct inoculation into a fermentation vessel or vat for the production of a dairy product, such as a fermented milk product or a cheese. The present composition may comprise the lactococcal bacteria in a concentrated form including liquid, frozen, dried or freeze-dried concentrates typically having a concentration of viable cells, which is in the range of 10⁴ to 10¹² cfu (colony forming units) per gram of the composition including at least 10⁴ cfu per gram of the composition, such as at least 10⁵ cfu/g, e.g. at least 10⁶ cfu/g, such as at least 10⁷ cfu/g, e.g. at least 10⁸ cfu/g, such as at least 10⁹ cfu/g, e.g. at least 10¹⁰ cfu/g, such as at least 10¹¹ cfu/g.

Preferably, in the present composition, the nisin-producing strain of Lactococcus, non-nisin degrading strain of Lactococcus, nisin-immune strain of Lactococcus are in frozen, dried or freeze-dried form as Direct Vat Set (DVS) culture and not as bulk starters.

The composition of the present invention may additionally comprise cryoprotectants, lyoprotectants, antioxidants, nutrients, fillers, flavorants or mixtures thereof. The composition may be in frozen or freeze-dried form. The composition preferably comprises one or more of cryoprotectants, lyoprotectants, antioxidants and/or nutrients, more preferably cryoprotectants, lyoprotectants and/or antioxidants and most preferably cryoprotectants or lyoprotectants, or both. Use of protectants such as croprotectants and lyoprotectantare known to a skilled person in the art. Suitable cryoprotectants or lyoprotectants include mono-, di-, tri-and polysaccharides (such as glucose, mannose, xylose, lactose, sucrose, trehalose, raffinose, maltodextrin, starch and gum arabic (acacia) and the like), polyols (such as erythritol, glycerol, inositol, mannitol, sorbitol, threitol, xylitol and the like), amino acids (such as proline, glutamic acid), complex substances (such as skim milk, peptones, gelatin, yeast extract) and inorganic compounds (such as sodium tripolyphosphate). Suitable antioxidants include ascorbic acid, citric acid and salts thereof, gallates, cysteine, sorbitol, mannitol, maltose. Suitable nutrients include sugars, amino acids, fatty acids, minerals, trace elements, vitamins (such as vitamin B-family, vitamin C). The composition may optionally comprise further substances including fillers (such as lactose, maltodextrin) and/or flavorants.

In an embodiment, the composition now disclosed may be a powder composition or a liquid composition, preferably wherein the powder composition is a freeze-dried powder composition or a spray dried powder composition.

The present invention also relates to a method for acidification of milk comprising the following steps:
adding the composition disclosed herein to milk to be acidified;
initiating the acidification of milk;
having acidified milk with a pH below 5.5 within 1-12 hours after adding the composition described herein.

In an embodiment, the step of having acidified milk with a pH below 5.5 is carried out within 1-6 hours, preferably within 2-5 hours, more preferably 5 hours after adding the composition herein disclosed.

In an embodiment, the method now disclosed comprises a step of having acidified milk with a pH of 4.5 within 10 hours after adding the composition herein disclosed.

This invention also relates to cheese obtainable by the method herein disclosed.

In the context of the present invention, the term “free of” or “lack of” or “voided of” means that the genome of a given strain does not present a sequence, or does not have a sequence, having at least 90% 95%, 96%, 97%, 98%, 99% or 100% sequence identity with SEQ ID NO: 7 or 8 (nsr−) and/or with SEQ ID NO: 4 (nisI−) and/or with SEQ ID NO: 5 (nisFEG−).

### BRIEF DESCRIPTION OF THE FIGURES

FIG. 1. NSR phenotype matching with the nsr genotype. The left two bars display the number of strains that were capable of degrading nisin in the NSR assay, whilst the two right bars show the NSR− phenotype. Genotype classification is shown in either filled bars (nsr+) or open bars (nsr−).

FIG. 2. Milk acidification in the presence of nisin. A nisin-sensitive strain does not acidify in the presence of nisin (black line), while a strain that is nisin-immune and non-nisin degrading does (dash-dotted line). The nisin degrading strain (dashed line) does acidify milk, but with a typical delay of a few hours as the strain first needs to sense the nisin molecules, subsequently produce the NSR enzyme so it can degrade nisin to such levels that can give unconstrained growth of the nisin-degrading strain.

### DETAILED DISCLOSURE OF THE INVENTION

A major problem in the cheese industry is spoilage by unwanted Clostridium strains. Nisin-producing strains are known to be used for the suppression of Clostridium growth in cheese. However, the use of a nisin-producing stains together with a starter culture may delay or prevent acidification, preventing the starter culture to perform as intended. Furthermore, the use of a nisin-producing strain (nisA+ or nisZ+ or nisQ+) together with a starter culture is also known to lead to inhibition of, for example, nisin-sensitive strains needed for favor- or phage resistance-purposes. On the other hand, strains may exist in the starter culture that compete with or even fight the nisin-producing strains or, most importantly for this invention, degrade the nisin produced, thereby preventing the nisin-producing strains to perform as intended. Therefore, it is undesirable to have nisin-degrading strain (nsr+). Furthermore, it is also undesirable to have strains that are not nisin-immune as that delays or even prevents acidification.

Therefore, there is a need to have a composition able to participate in the suppression of Clostridium growth in cheese while simultaneously allowing the starter culture to perform as expected. The present invention provides said composition.

### Culture conditions

Lactococcal strains from a high throughput screening (HTS) strain library were statically grown in M17 with either 2 g/v % glucose, 2 g/v % lactose or 1 g/v % glucose and 1 g/v % lactose at 30° C. for 16 hours. Sterile and pH-adjusted supernatants are obtained by first spinning down the cells in a centrifuge (Rotanta 46RSC; Hettich, Tuttlingen, Germany) for 5 min at 5.000 g. Supernatants were transferred to a new plate and pH adjusted to pH 6.0 by the addition of a calculated amount of 0.25 M NaOH. Finally, the pH-adjusted supernatants were sterile filtered in an AcroPrep™ 0.2 μm GHP membrane 96-well filter plate (Pall Corporation, USA). Milk used for fermentations is typically 94 ml heat-treated semi-skimmed milk or boiled milk (B-milk, 9.5% skim milk powder in water boiled at 100° C. for 30 minutes) with the addition of 5 ml pH-indicator based on bromocresol and 1 ml of 20 g/v % yeast-extract.

Acidification was followed by measuring HUE-values for every six minutes on a flatbed scanner. HUE-values are transformed to pH values using a calibration curve to obtain milk-acidification curves.

### Screening for Nisin Producing Strains

Sterile-filtered and pH adjusted supernatant (pH 6.0) of Lactococccus strains from the HTS-library are mixed with equal volumes to a 1% inoculum of an indicator strain, for example L. lactis WG-2 in fresh media. Growth of the indicator is measured and scored for inhibition caused by the tested supernatant.

### Nisin Sensitivity Test

Lactococcus strains acidified a semi skim milk-base with formate, complemented with 25 v/v % supernatant of non-nisin producing Lactococcus strain WG-2 or the same supernatant fortified with 0.5 μg/ml nisin (prepared from 0.2 mg/ml Chrisin (product of Chr. Hansen A/S Horsholm, Denmark with nisin as active ingredient)) at 30° C. for 16 hours and curves were obtained.

### NSR Assay

Lactococcus strains of the HTS-library acidified a B-milk sample containing 0.2 g/v % yeast extract containing 0.9 μg/ml nisin prepared from Chrisin solution. All samples were collected in plates, with every plate containing an inoculum of minimally one Lactococcus nsr⁻, for example L. lactis WG-2 and one Lactococcus nsr⁺ strain. Milk acidification was performed at 30° C. for 16 hours and curves were obtained. Acidified milk samples were frozen at −20° C. until measured at the HPLC-MS/MS. Chemical analysis by HPLC-MS/MS was done to measure the nisin A levels. Standardization of nisin levels was done per plate by taking the values of NSR− wells, such as the indicator strain L. lactis WG2 or was done against three wells with milk-base without cells.

Strains that do not acidify the milk-base to a pH<6.0 were qualified as ‘no acidification’ strains. Strains that have <15% of residual nisin A compared to the standard nisin level in the plate after a milk acidification were considered as ‘NSRpheno⁺’. The remaining strains were qualified as ‘NSRpheno⁻’.

Chemical NSR verification was conducted by first incubating a Chrisin solution with a NSR⁺ strain, and then searching for the nisin¹⁻²⁸ fragment by HPLC coupled to high resolution mass spectrometry (here a QTOF instrument), searching for the theoretical fragment C₁₁₄H₁₈₃N₃₃O₃0S₇ with a charge state of 1 to 10. From this the charge state 4 was most intense, and by MS/MS on the QTOF instrument, the fragmentation reaction (MRM) m/z 680.8>869.7 was found and shown to be specific for the nisin¹⁻²⁸ fragment. The analysis was subsequently transferred to a more sensitive instrument, a HPLC coupled to a triple-Q instrument (HPLC-MS/MS) also using the m/z 680.8>869.7 transition.

### Genotyping of 723 Strains

A total of 723 genome sequenced strains were phenotypically characterized. Of these strains a local blast database was made. This blast database was used as target input to perform a nisin gene or protein blast analysis. Query DNA and protein sequences of bacteriocins and its immunity genes are obtained from model organism whole genome sequences, publicly available on Pubmed or from bacteriocin database Bactibase (Hammami et al., 2010).

To identify the prevalence of the nsr gene encoding the nisin protease in lactococcal genomes, SEQ ID NO: 7 was selected as a query. The sequence, based on the lactococcal variant of the nisin protease (LaNSR) in the plasmid pSK11P (Siezen, Roland J., et al. “Complete sequences of four plasmids of Lactococcus lactis subsp. cremoris SK11 reveal extensive adaptation to the dairy environment.” Appl. Environ. Microbiol. 71.12 (2005): 8371-8382), contains the C-terminus of the full length nsr gene and can be used as a proxy sequence to indicate the nsr presence in gDNA of L. lactis strains. A gene was considered present in a genome if a hit with more than 90% query coverage and 80% identity was found.

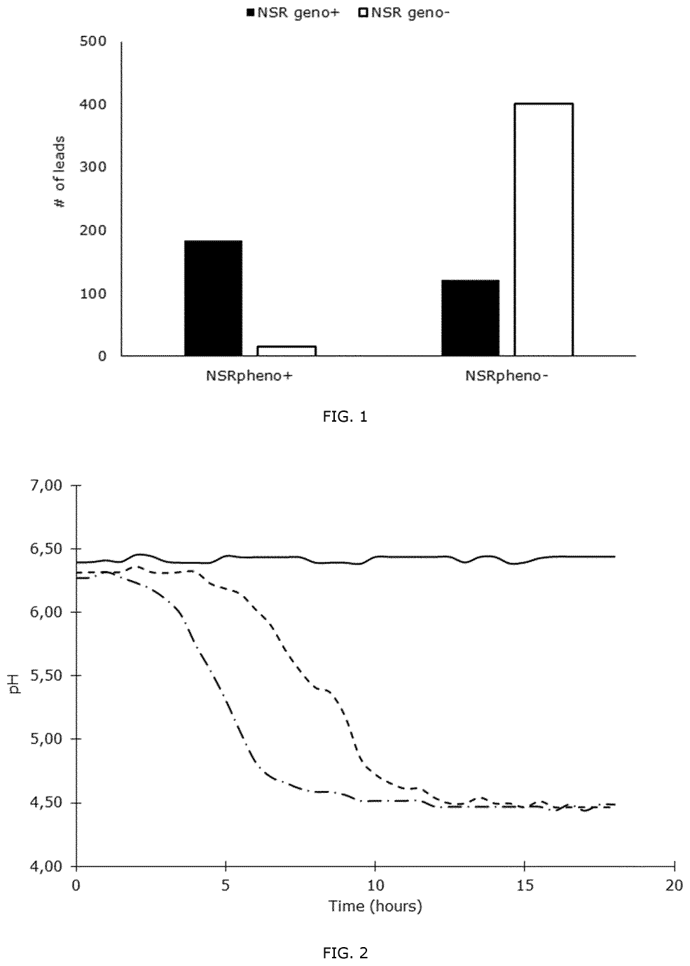

The NSR geno- and phenotype are linked (FIG. 1), whereby most strains with a nsr+ genotype are classified in the group of the nisin-degrading phenotypes (FIG. 2). Those strains are typically acidifying milk, even in the presence of nisin, but with a growth delay. It takes a certain amount of time for Lactococcus to produce NSR protease to subsequently reduce nisin levels. The time needed from gene activation to active nisin degradation may well explain the growth delay observed for this population of strains. A nsr gene serves here as a predictive marker for nisin-degradation.

Strains that are not capable of acidifying milk in the presence of nisin group mainly to the nisin-sensitive phenotype. These strains typically lack both the nisin immunity genes and the nsr gene to actively degrade nisin, therefore presenting a nsr− and nisIFEG-genotype.

When comparing the nsr genotype with its expected phenotype, it shows that most strains that do not have the nsr gene are also not capable of degrading the nisin in a milk acidification. When strains do not acidify in the presence of nisin, they are also classified with a NSR− phenotype, . Other reasons could be ineffective gene transcription or post-transcriptional defects leading to a lack of nisin degradation by NSR. On the other hand, strains with the capacity to degrade nisin are also strains with a nsr+ genotype. Overall, this method shows that out of 723 strains, the genotype of 585 strains was matched with the expected phenotype. This 81% prediction rate is high enough to predict the nsr genotype from the NSR phenotype and vice versa, confirming the usefulness of both the NSR phenotype assay and the pangenome mining for nsr.

### NisI and NisFEG Immunity in Combination with NSR Linked Nisin Degradation

The present inventions disclose that that strains without nisI, nisFEG and/or nsr genes are mainly sensitive to nisin. Possessing either nisI, nisFEG or a combination thereof increases the chance for the strain to be immune (FIG. 2).

Furthermore, holding the nsr gene and/or having a NSR phenotype results in a bias to the nisin degradation phenotype. A combination of nisI, nisFEG and nsr yields mainly a nisin immunity phenotype. No growth delay is caused for these strains, because while NSR is degrading nisin, the molecule is also pumped out of the cell. Thus, cells having all three systems are very well protected against the damaging effects of the nisin molecule, as it becomes very difficult for nisin to create pores when both nisin pumps and the protease are active in the attacked cells.

### EXAMPLES

### Example 1

Lactococcal strains were measured for their capacity to acidify milk in the presence and absence of 0.5 μg/ml nisin. To recognize these phenotypes, the Lactococcus strains must therefore be able to acidify milk. Strains were grouped in nisin-sensitive, nisin-degrading and nisin-immune types. FIG. 2 depicts the results obtained.

The nisin-sensitive strains are strains of which the pH drop is below 0.4 during milk acidification when exposed to nisin, but with larger pH drops without nisin being present in the milk.

The nisin-degrading strains are the ones capable of nisin degradation resulting in nisin degradation fragments. An undesirable consequence of nisin degradation is lowered nisin concentration.

The nisin-degrading strains were delayed in milk acidifications where nisin was added, leading to at least 1.5-hour delay compared to milk acidifications without nisin addition. The nisin-immune strains are defined as strains with acidification curves not affected by addition of nisin as compared to acidification without nisin. For these strains, the lag-time and the slope of the milk acidification curve is similar in the presence and absence of nisin (FIG. 2).

Therefore, FIG. 2 shows that a strain that is prepared in milk (pH 6.7) in sufficient amounts to reach pH 5.5 within 6 hours is said to be:
sensitive if the same strain preparation added to the milk supplemented with nisindoes not reach pH 6.3 within 12 hours (FIG. 2 black line);
degrading if the same strain preparation added to the milk supplemented with nisinreaches pH 5.5 at least 1.5 hours later and if the nisin is reduced below 15% of the initial amount added (FIG. 2 dashed line) or
immune if the same strain preparation added to the milk supplemented with nisinreaches pH 5.5 less than 1.5 hours later and if the nisin is above 15% of the amount added (FIG. 2 dash-dotted line).

### Example 2

The capacity of lactococcal strains to degrade nisin was also measured. A milk sample containing 0.9 μg/ml nisin was prepared by dissolving 200 mg Chrisin (Chr. Hansen A/S, Denmark) in 10 ml MQ water and 5 μl acetic acid, after which the solution was sterile filtered using a a Minisart 0.22 μm filter (Sartorius). A total of 400 μl of the nisin stock solution (452 μg/ml nisin A) was mixed with 200 ml of skim milk supplemented with 0.2% (w/v) sterile yeast extract. The milk sample was incubated with the tested strains for 16 hours. With HPLC-MS/MS analysis residual nisin and its NSR degradation product nisin¹⁻²⁸ were measured in the milk sample. Strains that could not acidify the milk pH below 6.0 were classified as non-acidifiers. Strains that degraded the nisin pool to less than 15% of the original nisin content were considered nisin degrading (NSR⁺), the remaining strains were considered non-nisin-degrading (NSR⁻).

### Example 3

The genotyping of important bacteriocin features of lactococcal strains was performed to link the phenotype from the first two experiments to presence of relevant bacteriocin genes. Lactococcal genes encoding for nisin-degradation nsr (plasmid pSK11P; encoding the C-terminus of the NSR proteinase) and nisin-immunity nisI and nisFEG (HM219853.1 Lactococcus lactis subsp. lactis nisin biosynthetic gene cluster) were obtained from public databases.

It can be shown, by combining the results of these three experiments, in particular for Lactococcus lactis, the nisin-immunity genotypes are linked to nisin-immunity in milk acidification and that nisin-degradation phenotype and genotype gives a distinct nisin-degrading phenotype during milk acidification, recognized as a delayed milk acidification (FIG. 2).

### SEQUENCES AND SEQUENCE LISTING

### Sequences

In an embodiment, the nisA gene may be encoded by a sequence having at least 95%, 96%, 97%, 98%, 99% or 100% sequence identity with SEQ ID NO: 1.

In an embodiment, the nisZ gene may be encoded by a sequence having at least 95%, 96%, 97%, 98%, 99% or 100% sequence identity with SEQ ID NO: 2.

In an embodiment, the nisQ gene may be encoded by a sequence having at least 95%, 96%, 97%, 98%, 99% or 100% sequence identity with SEQ ID NO: 3.

In an embodiment, the nisI gene may be encoded by a sequence having at least 90%, 95%, 96%, 97%, 98%, 99% /0 or 100% sequence identity with SEQ ID NO: 4.

In an embodiment, the nisFEG genes may be encoded by a sequence having at least 90%, 95%, 96%, 97%, 98%, 99% or 100% sequence identity with SEQ ID NO: 5.

In an embodiment, the nisBCTPRK genes may be encoded by a sequence having at least 90%, 95%, 96%, 97%, 98%, 99% or 100% sequence identity SEQ ID NO: 6.

In an embodiment, the nsr gene may be encoded by a sequence having at least 90%, 95%, 96%, 97%, 98%, 99% or 100% sequence identity with SEQ ID NO: 7 or 8.

SEQUENCE LISTING
(nisA gene)
SEQ ID NO: 1
ATTACAAGTATTTCGCTATGTACACCCGGTTGTAAAACAGGAGCTCTGATGGGTTGTAACATG
AAAACAGCAACTTGTCATTGTAGTATTCACGTAAGCAAATAA
(nisZ gene)
SEQ ID NO: 2
ATTACAAGTATTTCGCTATGTACACCCGGTTGTAAAACAGGAGCTCTGATGGGTTGTAACATG
AAAACAGCAACTTGTAATTGTAGTATTCACGTAAGCAAATAA
(nisQ gene)
SEQ ID NO: 3
ATTACCAGCATTTCGCTTTGTACACCAGGTTGTAAAACAGGTGTTCTGATGGGATGTAACCTG
AAAACAGCAACTTGTAATTGTAGCGTTCACGTAAGCAAATAA
(nisI gene)
SEQ ID NO: 4
ATGAGAAGATATTTAATACTTATTGTGGCCTTAATAGGGATAACAGGTTTATCAGGGTGTTATC
AAACAAGTCATAAAAAGGTGAGGTTTGACGAAGGAAGTTATACTAATTTTATTTATGATAATAA
ATCGTATTTCGTAACTGATAAGGAGATTCCTCAGGAGAACGTTAACAATTCCAAAGTAAAATTT
TATAAGCTGTTGATTGTTGACATGAAAAGTGAGAAACTTTTATCAAGTAGCAACAAAAATAGTG
TGACTTTGGTCTTAAATAATATTTATGAGGCTTCTGACAAGTCGCTATGTATGGGTATTAACGA
CAGATACTATAAGATACTTCCAGAAAGTGATAAGGGGGCGGTCAAAGCTTTGAGATTACAAAA
CTTTGATGTGACAAGCGATATTTCTGATGATAATTTTGTTATTGATAAAAATGATTCACGAAAAA
TTGACTATATGGGAAATATTTACAGTATATCGGACACCACCGTATCTGATGAAGAATTGGGAG
AATATCAGGATGTTTTAGCTGAAGTACGTGTGTTTGATTCAGTTAGTGGCAAAAGTATCCCGA
GGTCTGAATGGGGGAGAATTGATAAGGATGGTTCAAATTCCAAACAGAGTAGGACGGAATGG
GATTATGGCGAAATCCATTCTATTAGAGGAAAATCTCTTACTGAAGCATTTGCCGTTGAGATAA
ATGATGATTTTAAGCTTGCAACGAAGGTAGGAAACTAG
(nisFEG genes)
SEQ ID NO: 5
ATGCAGGTAAAAATTCAAAATCTTTCTAAAACATATAAAGAAAAGCAGGTGCTACAAGATATCA
GTTTTGATATTAAATCTGGAACAGTCTGTGGTTTATTAGGAGTTAACGGTGCAGGAAAATCAAC
TTTGATGAAAATTTTGTTTGGTTTAATTTCTGCAGATACTGGAAAAATTTTTTTTGATGGACAAG
AAAAGACAAATAATCAACTTGGAGCCTTAATCGAGGCTCCAGCAATATATATGAATTTATCTGC
TTTCGATAATCTTAAAACTAAGGCTTTGCTTTTTGGAATTTCAGATAAGAGAATTCATGAAACTC
TAGAAGTGATTGGTTTGGCAGAAACAGGAAAGAAAAGAGCAGGAAAATTCTCTTTAGGGATG
AAACAACGTTTGGGAATTGGTATGGCTATTCTTACAGAACCTCAATTTTTAATTCTTGATGAAC
CTACTAATGGTTTGGATCCTGATGGTATTGCGGAGTTGTTAAACTTAATCTTAAAACTTAAAGC
TAAAGGTGTGACAATCTTGATTTCTAGTCATCAGTTGCACGAAATAAGTAAAGTAGCTAGTCAA
ATTATTATTTTGAACAAAGGTAAGATTCGTTATAATCATGCGAACAATAAAGAAGACGACATTG
AACAGTTATTCTTTAAGATTGTGCATGGAGGAATGTGATATGAAAAGAATAATAGCATCAGAA
GCAATAAAATTAAAAAAATCAGGAACTCTTAGATTGGTATTAATTATCCCTTTTGTGACTCTATT
TATAGCATTTCTTATGGGTGGAATACAGATTTTTAGTGTTTTTTCAATTTATTGGTGGGAAACTG
GTTTTTTATTCCTTTTGATGAGTTTGCTTTTTCTTTATGATATAAAATCAGAGGAGCAAGCTGGA
AATTTTCAAAATGTGAAATGGAAAAAGCTGAGTTGGAAAATTCATTTGGCCAAAATGTTGTTGA
TTTGGCTAAGAGGTATACTAGCGAGCATAGTCTTGATTATTTTGCTTTATTTGGTTGCTTTTGT
GTTTCAAGGTATTGTAGTGGTGGATTTTATGAAAGTAAGTGTGGCATTGATTGCTATATTACTA
GCAGCTTCTTGGAATTTACCCTTTATATACTTGATTTTCAAGTGGATTAATACTTACGTATTGTT
AGCTGCGAATACCTTGATTTGTTTAATTGTTGCCCCTTTTGTTGCACAAACTCCAGTATGGTTC
TTGCTACCATACACTTATCACTATAAAGTTACAGAAAGTTTGTTAAATATCAAACCATCAGGAG
ATTTGTTAACAGGGAAGATAAATTTCAGTATTTGGGAAGTTTTATTACCATTTGGACTTTCCATA
GTTGTAACGATAGGAGTTTCGTATTTACTTAAAGGAGTGATAGAACATGATAAGAAGTGAATG
TCTCAAATTAAAAAATAGCTTAGGGTTTTATTTAGTTTTTCTCTTTACTTTATTAGAGCTTTTAAC
GGTTCCTATTTATTTAGCTTTTGGAAGAAGTCATGTTTCAATGACTGATTTATCGCTCATGATTT
TTTTGTTTTTTCCGTTACTGGTTACAATTTTGTCTATTCTAATCTTTGAACAGGAGAGTCTGGCC
AATCGTTTCCAAGAAATAAATGTAAATAAAAAAAGTAGCAGAATTTGGTTATCAAAGCTAATAG
TAGTGGATTTCCTTTTGTTCTTTCCATCAGCAATGATCTGGATAATTACGGGAGTTTCACAGGC
AGTAGGGCAACAAGGAATGATGATCGCAACAGCTAGCTGGTTGATGGCAATTTTTCTTAATCA
TTTTCATCTTTTATTGACCTTTATAATCAATCGAGGAGGGAGCATGATTATCGCGATTATTGAA
ATATTACTCATTATTTTTGCCAGTAATAAAGTTTTATTAGCAGCTTATTGGTGTCCCATTGCTTT
ACCTGTTAATTTTATGATAACTGGGCGGTGTGCTTATCTGATAGCTGCCGTAGGGTGGATTGT
TTTATCCACAATAATTCTTGTAGCATTATCTAAAAAAAAGATTAGATAA
(nisBCTPRK genes)
SEQ ID NO: 6
CCAAATCAAAGGATAGTATTTTGTTAGTTCAGACATGGATACTATCCTATTTTTATAAGTTATTT
AGGGTTGCTAAATAGCTTATAAAAATAAAGAGAGGAAAAAACATGATAAAAAGTTCATTTAAAG
CTCAACCGTTTTTAGTAAGAAATACAATTTTATCTCCAAACGATAAACGGAGTTTTACTGAATAT
ACTCAAGTCATTGAGACTGTAAGTAAAAATAAAGTTTTTTTGGAACAGTTACTACTAGCTAATC
CTAAACTCTATGATGTTATGCAGAAATATAATGCTGGTCTGTTAAAGAAGAAAAGGGTTAAAAA
ATTATTTGAATCTATTTACAAGTATTATAAGAGAAGTTATTTACGATCAACTCCATTTGGATTAT
TTAGTGAAACTTCAATTGGTGTTTTTTCGAAAAGTTCACAGTACAAGTTAATGGGAAAGACTAC
AAAGGGTATAAGATTGGATACTCAGTGGTTGATTCGCCTAGTTCATAAAATGGAAGTAGATTT
CTCAAAAAAGTTATCATTTACTAGAAATAATGCAAATTATAAGTTTGGAGATCGAGTTTTTCAA
GTTTATACCATAAATAGTAGTGAGCTTGAAGAAGTAAATATTAAATATACGAATGTTTATCAAA
TTATTTCTGAATTTTGTGAGAATGACTATCAAAAATATGAAGATATTTGTGAAACTGTAACGCTT
TGCTATGGAGACGAATATAGAGAACTATCGGAACAATATCTTGGCAGTCTGATAGTTAATCATT
ATTTGATCTCTAATTTACAAAAAGATTTGTTGTCAGATTTTTCTTGGAACACTTTTTTGACTAAA
GTTGAAGCAATAGATGAAGATAAAAAATATATAATTCCTCTGAAAAAAGTTCAAAAGTTTATTC
AAGAATACTCAGAAATAGAAATTGGTGAAGGTATTGAGAAACTGAAAGAAATATATCAGGAAA
TGTCACAAATTCTTGAGAATGATAATTATATTCAAATTGATTTAATTAGTGATAGTGAAATAAAT
TTTGATGTTAAACAAAAGCAACAATTAGAACATTTAGCTGAGTTTTTAGGAAATACGACAAAAT
CTGTAAGAAGAACATATTTGGATGACTATAAGGATAAATTTATCGAAAAATATGGTGTAGATCA
AGAAGTACAAATAACAGAATTATTTGATTCTACATTTGGCATAGGAGCTCCATATAATTATAAT
CATCCTCGAAATGACTTTTATGAGTCCGAACCGAGTACTCTATACTATTCAGAAGAGGAGAGA
GAAAAGTACCTCAGCATGTATGTAGAAGCCGTTAAAAATCATAATGTAATTAATCTTGACGACT
TAGAGTCTCATTATCAAAAAATGGACTTAGAAAAGAAAAGTGAACTTCAAGGGTTAGAATTATT
TTTGAATTTGGCAAAGGAGTATGAAAAAGATATTTTTATTTTAGGGGATATCGTTGGAAATAAT
AATTTGGGAGGGGCATCAGGTAGATTTTCTGCACTCTCTCCGGAGTTAACAAGTTATCATAGA
ACGATAGTAGATTCTGTCGAAAGAGAAAATGAGAATAAAGAAATTACATCGTGTGAAATAGTA
TTTCTTCCAGAAAATATCAGACATGCTAACGTTATGCATACATCAATTATGAGGAGGAAAGTAC
TTCCATTTTTTACAAGTACAAGTCACAATGAAGTTCTGTTAACTAATATCTATATTGGAATAGAC
GAAAAAGAAAAATTTTATGCACGAGACATTTCAACTCAAGAGGTATTGAAATTCTACATTACAA
GCATGTACAATAAAACGTTATTCAGTAATGAGCTAAGATTTCTTTACGAAATTTCATTAGATGA
CAAGTTTGGTAATTTACCTTGGGAACTTATTTACAGAGACTTTGATTATATTCCACGTTTAGTAT
TTGACGAAATAGTAATATCTCCTGCTAAATGGAAAATTTGGGGAAGGGATGTAAATAGTAAGA
TGACAATAAGAGAACTTATTCAAAGCAAAGAAATTCCCAAAGAGTTTTATATTGTCAATGGAGA
TAATAAAGTTTATTTATCACAGGAAAACCCATTGGATATGGAAATTTTAGAGTCGGCGATAAAG
AAGAGCTCAAAAAGAAAAGATTTTATAGAGCTACAAGAATATTTTGAAGATGAAAATATCATAA
ATAAAGGAGAAAAGGGGAGAGTTGCCGATGTTGTAGTGCCTTTTATTAGAACGAGAGCATTAG
GTAATGAAGGGAGAGCATTTATAAGAGAGAAAAGAGTTTCGGTTGAACGGCGTGAAAAATTG
CCCTTTAACGAGTGGCTTTATCTAAAGTTGTACATTTCTATAAATCGTCAAAATGAATTTTTACT
GTCGTATCTTCCAGATATTCAGAAAATAGTAGCAAACCTGGGTGGAAATCTATTCTTCCTAAGA
TATACTGATCCTAAACCACATATTAGATTGCGTATAAAATGTTCAGATTTATTTTTAGCTTACGG
ATCTATTCTTGAAATCTTAAAAAGGAGTCGGAAAAATAGGATAATGTCAACTTTTGATATTTCTA
TTTATGATCAAGAAGTAGAAAGATATGGTGGATTTGATACTTTAGAGTTATCCGAAGCAATATT
TTGTGCCGATTCTAAAATTATTCCAAATTTGCTTACATTGATAAAAGATACTAATAATGATTGGA
AAGTCGATGATGTATCAATCTTGGTGAATTATTTATATCTGAAATGCTTCTTTGAGAATGATAA
CAAAAAGATTCTTAATTTTTTGAATTTAGTTAGTCCTAAAAAGGTTAAAGAAAATGTCAATGAAA
AGATTGAACATTATCTTAAGCTTCTGAAAGTTAATAATCTAGGTGACCAAATTTTTTATGACAAG
AATTTTAAAGAATTAAAGCATGCCATAAAAAATTTATTTTTAAAAATGATAGCTCAAGATTTTGA
ACTTCAGAAAGTTTATTCAATTATTGACAGTATCATTCATGTCCATAATAACCGACTAATTGGTA
TTGAACGAGATAAAGAGAAATTAATTTATTACACACTTCAAAGGTTGTTTGTTTCGGAAGAATA
CATGAAATGAGGACTAATAGATGGATGAAGTGAAAGAATTCACATCAAAACAATTTTTTAATAC
TTTACTTACTCTTCCAAGCACCTTGAAGTTAATTTTTCAGTTGGAAAAACGTTATGCAATTTATT
TAATTGTGCTAAATGCTATCACAGCTTTTGTTCCGTTGGCTAGTCTTTTTATTTATCAAGATTTA
ATAAACTCTGTGCTAGGTTCAGGGAGACATCTTATCAATATTATTATCATCTATTTTATTGTTCA
AGTGATAACAACAGTTCTGGGACAGCTGGAAAGTTATGTTAGTGGAAAATTTGATATGCGACT
TTCTTACAGTATCAATATGCGCCTCATGAGGACTACCTCATCTCTTGAATTAAGTGATTATGAG
CAGGCTGATATGTATAATATCATAGAAAAAGTTACTCAAGACAGCACTTACAAGCCTTTTCAGC
TATTTAATGCTATCATTGTTGTGCTTTCATCGTTTATCTCATTGTTATCTAGTCTATTTTTTATTG
GAACATGGAACATTGGGGTAGCAATTTTACTCCTTATTGTTCCAGTATTATCTTTGGTACTTTTT
CTCAGAGTGGGACAATTAGAGTTTTTAATCCAGTGGCAGAGAGCAAGTTCTGAAAGAGAAACA
TGGTATATTGTATATTTATTGACTCATGATTTTTCATTTAAAGAAATCAAGTTAAATAATATTAG
CAATTACTTCATTCATAAATTTGGAAAATTAAAGAAAGGATTTATCAACCAAGATTTAGCTATTG
CTCGTAAGAAGACATATTTCAATATTTTTCTTGATTTCATTTTGAATTTGATAAATATTCTTACGA
TATTTGCTATGATCCTTTCGGTAAGAGCAGGAAAACTTCTTATAGGTAATTTGGTAAGTCTCAT
ACAAGCTATTTCTAAAATCAATACTTATTCTCAAACAATGATTCAAAATATTTACATCATTTATAA
TACTAGTTTGTTTATGGAACAACTTTTTGAGTTTTTAAAGAGAGAAAGTGTAGTTCACAAAAAA
ATAGAAGATACTGAAATATGCAATCAACATATAGGAACTGTTAAAGTAATTAATTTATCATATGT
TTACCCTAATTCGAATGCCTTTGCACTAAAGAATATCAATTTATCCTTTGAAAAAGGAGAATTAA
CTGCTATTGTAGGAAAAAATGGTTCAGGGAAAAGTACACTAGTAAAGATAATTTCAGGATTATA
TCAACCAACTATGGGAATAATCCAATACGACAAAATGAGAAGTAGTTTGATGCCTGAGGAGTT
TTATCAGAAAAACATATCGGTGCTGTTCCAAGATTTTGTGAAGTATGAGTTAACGATAAGAGA
GAATATAGGATTGAGTGATTTGTCTTCTCAATGGGAAGATGAGAAAATTATTAAAGTACTAGAT
AATTTAGGACTCGATTTTTTGAAAACTAATAATCAATATGTACTTGATACGCAGTTAGGAAATT
GGTTTCAAGAAGGGCATCAACTTTCAGGAGGTCAGTGGCAAAAAATTGCATTAGCAAGGACAT
TCTTTAAGAAAGCTTCAATTTATATTTTAGATGAACCAAGTGCTGCACTCGATCCTGTAGCTGA
AAAAGAAATATTTGATTATTTTGTTGCTCTTTCGGAAAATAATATTTCAATTTTCATTTCTCATAG
TTTGAATGCTGCCAGAAAAGCAAATAAAATCGTGGTTATGAAAGATGGACAGGTCGAAGATGT
TGGAAGTCATGATGTCCTTCTGAGAAGATGTCAATACTATCAAGAACTTTATTATTCAGAGCAA
TATGAGGATAATGATGAATAAAAAAAATATAAAAAGAAATGTTGAAAAAATTATTGCTCAATGG
GATGAGAGAACTAGAAAAAATAAAGAAAACTTCGATTTCGGAGAGTTGACTCTCTCTACAGGA
TTGCCTGGTATAATTTTAATGTTAGCGGAGTTAAAAAATAAAGATAACTCAAAGATATATCAGA
AAAAGATAGACAATTATATTGAATATATTGTTAGCAAACTTTCAACATATGGGCTTTTAACAGG
ATCACTTTATTCGGGAGCAGCTGGCATTGCATTAAGTATCCTACATTTACGAGAAGATGACGA
AAAATATAAGAATCTTCTTGATAGCCTAAATAGATATATCGAATATTTCGTCAGAGAAAAAATT
GAAGGATTTAATTTGGAAAACATTACTCCTCCTGATTATGACGTGATTGAAGGTTTATCTGGGA
TACTTTCCTATCTATTATTAATCAACGACGAGCAATATGATGATTTGAAAATACTCATTATCAAT
TTTTTATCAAATCTGACTAAAGAAAACAAAGGACTAATATCGCTTTACATCAAATCGGAGAATC
AGATGTCTCAATCAGAAAGTGAGATGTATCCACTAGGCTGTTTGAATATGGGATTAGCACATG
GACTTGCTGGAGTGGGCTGTATCTTAGCTTATGCCCACATAAAAGGATATAGTAATGAAGCCT
CGTTGTCAGCTTTGCAAAAAATTATTTTTATTTATGAAAAGTTTGAACTTGAAAGGAAAAAACA
GTTTCTATGGAAAGATGGACTTGTAGCAGATGAATTAAAAAAAGAGAAAGTAATTAGGGAAGC
AAGTTTCATTAGAGATGCATGGTGCTATGGAGGTCCAGGTATTAGTCTGCTATACTTATACGG
AGGATTAGCACTGGATAATGACTATTTTGTAGATAAAGCAGAAAAAATATTAGAGTCAGCTATG
CAAAGGAAACTTGGTATTGATTCATATATGATTTGCCATGGCTATTCTGGTTTAATAGAAATTT
GTTCTTTATTTAAGCGGCTATTAAATACAAAAAAGTTTGATTCATACATGGAAGAATTTAATGTT
AATAGTGAGCAAATTCTTGAAGAATACGGAGATGAAAGTGGCACGGGTTTTCTTGAAGGAATA
AGTGGCTGTATACTGGTATTATCGAAATTTGAATATTCAATCAATTTTACTTATTGGAGACAAG
CACTGTTACTTTTTGACGATTTTTTGAAAGGAGGGAAGAGGAAATGAGAAGATATTTAATACTT
ATTGTGGCCTTAATAGGGATAACAGGTTTATCAGGGTGTTATCAAACAAGTCATAAAAAGGTG
AGGTTTGACGAAGGAAGTTATACTAATTTTATTTATGATAATAAATCGTATTTCGTAACTGATAA
GGAGATTCCTCAGGAGAACGTTAACAATTCCAAAGTAAAATTTTATAAGCTGTTGATTGTTGAC
ATGAAAAGTGAGAAACTTTTATCAAGTAGCAACAAAAATAGTGTGACTTTGGTCTTAAATAATA
TTTATGAGGCTTCTGACAAGTCGCTATGTATGGGTATTAACGACAGATACTATAAGATACTTCC
AGAAAGTGATAAGGGGGCGGTCAAAGCTTTGAGATTACAAAACTTTGATGTGACAAGCGATAT
TTCTGATGATAATTTTGTTATTGATAAAAATGATTCACGAAAAATTGACTATATGGGAAATATTT
ACAGTATATCGGACACCACCGTATCTGATGAAGAATTGGGAGAATATCAGGATGTTTTAGCTG
AAGTACGTGTGTTTGATTCAGTTAGTGGCAAAAGTATCCCGAGGTCTGAATGGGGGAGAATTG
ATAAGGATGGTTCAAATTCCAAACAGAGTAGGACGGAATGGGATTATGGCGAAATCCATTCTA
TTAGAGGAAAATCTCTTACTGAAGCATTTGCCGTTGAGATAAATGATGATTTTAAGCTTGCAAC
GAAGGTAGGAAACTAGAGTGAAAAAAATACTAGGTTTCCTTTTTATCGTTTGTTCGTTGGGTTT
ATCAGCAACTGTGCATGGGGAGACAACAAATTCACAACAGTTACTCTCAAATAATATTAATACG
GAATTAATTAATCATAATTCTAATGCAATTTTATCTTCAACAGAGGGATCAACGACTGATTCGAT
TAATCTAGGGGCGCAGTCACCTGCAGTAAAATCGACAACAAGGACTGAATTGGATGTAACTGG
TGCTGCTAAAACTTTATTACAGACATCAGCTGTTCAAAAAGAAATGAAAGTTTCGTTGCAAGAA
ACTCAAGTTAGTTCTGAATTCAGTAAGAGAGATAGCGTTACAAATAAAGAAGCAGTTCCAGTAT
CTAAGGATGAGCTACTTGAGCAAAGTGAAGTAGTCGTTTCAACATCATCGATTCAAAAAAATAA
AATCCTCGATAATAAGAAGAATAGAGCTAACTTCGTTACTTCCTCTCCGCTTATTAAGGAAAAA
CCATCAAATTCTAAAGATGCATCTGGTGTAATTGATAATTCTGCTTCTCCTCTATCTTATCGTAA
AGCTAAGGAAGTGGTATCTCTTAGACAACCTTTAAAAAATCAAAAAGTAGAGGCACAACCTCT
ATTGATAAGTAATTCTTCTGAAAAGAAAGCAAGTGTTTATACAAATTCACATGATTTTTGGGATT
ATCAGTGGGATATGAAATATGTGACAAATAATGGAGAAAGCTATGCGCTCTACCAGCCCTCAA
AGAAAATTTCTGTTGGAATTATTGATTCAGGAATCATGGAAGAACATCCTGATTTGTCAAATAG
TTTAGGAAATTATTTTAAAAATCTTGTTCCTAAGGGAGGGTTTGATAATGAAGAACCTGATGAA
ACTGGAAATCCAAGTGATATTGTCGACAAAATGGGACACGGGACGGAAGTCGCAGGTCAGAT
TACAGCAAATGGTAATATTTTAGGAGTAGCACCAGGGATTACTGTAAATATATACAGAGTATTT
GGTGAAAATCTTTCGAAATCGGAATGGGTAGCTAGAGCAATAAGAAGAGCTGCGGATGATGG
GAACAAGGTCATCAATATAAGTGCTGGACAGTATCTTATGATTTCAGGATCGTATGATGATGG
AACAAATGATTATCAAGAGTATCTTAATTATAAGTCAGCAATAAATTATGCAACAGCAAAAGGA
AGTATTGTTGTCGCAGCTCTTGGTAATGATAGTTTAAACATACAAGATAACCAAACAATGATAA
ACTTTCTTAAGCGTTTCAGAAGTATAAAGGTTCCTGGAAAAGTTGTAGATGCACCGAGTGTATT
TGAGGATGTAATAGCCGTAGGTGGAATAGATGGTTATGGTAATATTTCTGATTTTAGTAATATT
GGAGCGGATGCAATTTATGCTCCTGCTGGCACAACGGCCAATTTTAAAAAATATGGGCAAGAT
AAATTTGTCAGTCAGGGTTATTATTTGAAAGATTGGCTTTTTACAACTACTAATACTGGCTGGT
ACCAATATGTTTATGGCAACTCATTTGCTACTCCTAAAGTATCTGGGGCACTGGCATTAGTAGT
TGATAAATATGGAATAAAGAATCCTAACCAACTAAAAAGGTTTCTTCTAATGAATTCTCCAGAA
GTTAATGGGAATAGAGTATTGAATATTGTTGATTTATTGAATGGGAAAAATAAAGCTTTTAGCT
TAGATACAGATAAAGGTCAGGATGATGCTATTAACCATAAATCGATGGAGAATCTTAAAGAGT
CTAGGGATACAATGAAACAGGAACAAGATAAAGAAATTCAAAGAAATACAAATAACAATTTTTC
TATCAAAAATGATTTTCATAACATTTCAAAAGAAGTAATTTCAGTTGATTATAATATTAATCAAA
AAATGGCTAATAATCGAAATTCGAGAGGTGCTGTTTCTGTACGAAGTCAAGAAATTTTACCTGT
TACTGGAGATGGAGAAGATTTTTTACCGGCTTTAGGTATAGTGTGTATCTCAATCCTTGGTATA
TTGAAAAGAAAGACTAAAAATTGATAGATTATATTTCTTCAGAATGAATGGTATAATGAAGTAA
TGAGTACTAAACAATCGGAGGTAAAGTGGTGTATAAAATTTTAATAGTTGATGATGATCAGGA
AATTTTAAAATTAATGAAGACAGCATTAGAAATGAGAAACTATGAAGTTGCGATGCATCAAAAC
ATTTCACTTCCCTTGGATATTACTGATTTTCAGGGATTTGATTTGATTTTGTTAGATATCATGAT
GTCAAATATTGAAGGGACAGAAATTTGTAAAAGGATTCGCAGAGAAATATCAACTCCAATTATC
TTTGTTAGTGCGAAAGATACAGAAGAGGATATTATAAACGGCTTAGGTATTGGTGGGGATGAC
TATATTACTAAGCCTTTTAGCCTTAAACAGTTGGTTGCAAAAGTGGAAGCAAATATAAAGCGAG
AGGAACGCAATAAACATGCAGTTCATGTTTTTTCAGAGATTCGTAGAGATTTAGGACCAATTAC
ATTTTATTTAGAAGAAAGGCGAGTCTGTGTCAATGGTCAAACAATTCCACTGACTTGTCGTGAA
TACGATATTCTTGAATTACTATCACAACGAACTTCTAAAGTTTATACGAGAGAGGATATTTATG
ATGACGTATATGATGAATATTCTAATGCACTTTTTCGGTCAATCTCGGAATATATTTATCAGATT
AGGAGTAAGTTTGCACCATACGATATTAATCCGATAAAAACGGTTCGGGGACTTGGGTATCAG
TGGCATGGGTAAAAAATATTCAATGCGTCGACGGATATGGCAAGCTGTCATTGAAATTATCAT
AGGTACTTGTCTACTTATCCTGTTGTTACTGGGCTTGACTTTCTTTCTACGACAAATTGGACAA
ATCAGTGGTTCAGAAACTATTCGTTTATCTTTAGATTCAGATAATTTAACTATTTCTGATATCGA
ACGTGATATGAAACACTACCCATATGATTATATTATTTTTGACAATGATACAAGTAAAATTTTGG
GAGGACATTATGTCAAGTCGGATGTACCTAGTTTTGTAGCTTCAAAACAGTCTTCACATAATAT
TACAGAAGGAGAAATTACTTATACTTATTCAAGCAATAAGCATTTTTCAGTTGTTTTAAGACAAA
ACAGTATGCCTGAATTTACAAATCATACGCTTCGTTCAATTTCTTATAATCAATTTACTTACCTT
TTCTTTTTTCTTGGTGAAATAATACTCATTATTTTTTCTGTCTATCATCTCATTAGAGAATTTTCT
AAGAATTTTCAAGCCGTTCAAAAGATTGCATTGAAGATGGGGGAAATAACTACTTTTCCTGAAC
AAGAGGAATCAAAAATTATTGAATTTGATCAGGTTCTGAATAACTTATATTCGAAAAGTAAGGA
GTTAGCTTTCCTTATTGAAGCGGAGCGTCATGAAAAACATGATTTATCCTTCCAGGTTGCTGCA
CTTTCACATGATGTTAAGACACCTTTAACAGTATTAAAAGGAAATATTGAACTGCTAGAGATGA
CTGAAGTAAATGAACAACAAGCTGATTTTATTGAGTCAATGAAAAATAGTTTGACTGTTTTTGA
CAAGTATTTTAACACAATGATTAGTTATACAAAACTTTTGAATGATGAAAATGATTACAAAGCG
ACAATCTCCCTGGAGGATTTTTTGATAGATTTATCAGTTGAGTTGGAAGAGTTGTCAACAACTT
ATCAAGTGGATTATCAGCTAGTTAAAAAAACAGATTTAACCACTTTTTACGGAAATACATTAGC
TTTAAGTCGAGCACTTATCAATATCTTTGTTAATGCCTGTCAGTATGCTAAAGAGGGTGAAAAA
ATAGTCAGTTTGAGTATTTATGATGATGAAAAATATCTCTATTTTGAAATCTGGAATAATGGTCA
TCCTTTTTCTGAACAAGCAAAAAAAAATGCTGGAAAACTATTTTTCACAGAAGATACTGGACGT
AGTGGGAAACACTATGGGATTGGACTATCTTTTGCTCAAGGTGTAGCTTTAAAACATCAAGGA
AACTTAATTCTCAGTAATCCTCAAAAAGGTGGGGCAGAAGTTATCCTAAAAATAAAAAAGTAA
(nsr gene, C-terminus)
SEQ ID NO: 7
GTGCTCCATAGAAAAAATGGTTCTGATTCAGCAGGTTATACTTCTGCTAATCAAACCGTCTATT
TATATGATGGCTCAACATTACAAATAACTTCTGCTTTTGTAAAAGACAGAACAAATAATATTTAT
AAAAATTTTCCTATTAGTCCGGACATTCAAACAAATAATGCTAAAAGTTCTGCAATAGAATGGA
TAAAATCTCAAATAAAGTAA
(nsr gene, full length)
SEQ ID NO: 8
ATGAAAATAGGTAAGCGCATTTTATTAGGTCTAGTGGCAGTATGTGCTTTATTTTTAGGAATTA
TCTATCTTTGGGGGTATAAATTCAACATATATTTAGTACCACCCTCCCCTCAGAAGTATGTTCG
AGTTGCCTTAAAAAATATGGATGAACTTGGGCTATTTACTGATTCAAAAGAATGGGTAGAAACT
AAAAAAAAGACGATAGAAGAAACATCAAATGCTAAAAACTATGCAGAAACAATCCCTTTTTTAC
AAAAAGCGATTAAAGTTGCAGGAGGAAAGCATTCTTTTATTGAACATGAAGAAGACATATCAA
AAAGAAGCATGACAAAATATATAAAACCAAAGGCAGAAATCGAAGGCAACACTTTAATATTAA
CTATTCCTGAATTTACTGGAAATGATAGTCAAGCATCTGATTACGCTAATTTTTTAGAATCTTCA
TTGCATAAAAACAATTATAATGGGGTAATTGTTGATTTGAGGGGGAATAGAGGTGGAGACTTA
TCTCCTATGGTATTAGGATTATCCCCCCTATTGCCTGATGGAACTCTATTTACTTATGTTGATAA
AAGTAGTCATTCTAAACCTGTTGAACTACAAAATGGAGAAATAAATAGTGGCGGGTCATCAAC
AAAAATAAGTGATAATAAAAAAATTAAAAAAGCTCCTATTGCTGTATTAATAGATAATAATACA
GGGAGCTCCGGCGAATTAACCGCTTTGTGCTTTGAGGGAATACCTAATGTTAAATTTTTGGGT
TCTGATTCAGCAGGTTATACTTCTGCTAATCAAACCGTCTATTTATATGATGGCTCAACATTACA
AATAACTTCTGCTTTTGTAAAAGACAGAACAAATAATATTTATAAAAATTTTCCTATTAGTCCGG
ACATTCAAACAAATAATGCTAAAAGTTCTGCAATAGAATGGATAAAATCTCAAATAAAGTAA

For purposes of the present invention, the degree of “sequence identity” between two amino acid sequences is determined using the Needleman-Wunsch algorithm (Needleman and Wunsch, 1970, J. Mol. Biol. 48: 443-453) as implemented in the Needle proGram of the EMBOSS package (EMBOSS: The European Molecular Biology Open Software Suite, Rice et al.ᵣ 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the nobrief option) is used as the percent identity and is calculated as follows:

$$( Identical Residue \times 100 ) / ( Length of Alignment - Total Number of Gaps in Alignment )$$

For purposes of the present invention, the degree of sequence identity between two deoxyribonucleotide sequences is determined using the Needleman-Wunsch algorithm (Needleman and Wunsch, 1970, supra) as implemented in the Needle proGram of the EMBOSS package (EMBOSS: The European Molecular Biology Open Software Suite, Rice et al., 2000, supra), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

$$( Identical Deoxyribonucleotides \times 100 ) / ( Length of Alignment - Total Number of Gaps in Alignment ) .$$

### REFERENCES

Chandrapati S, O'Sullivan D J. Characterization of the promoter regions involved in galactose-and nisin-mediated induction of the nisA gene in Lactococcus lactis ATCC 11454. Molecular microbiology. 2002 October;46(2):467-77.

Clemens R, Zaschke-Kriesche J, Khosa S, Smits S H. Insight into Two ABC Transporter Families Involved in Lantibiotic Resistance. Frontiers in molecular biosciences. 2018 Jan. 22;4:91.

Delves-Broughton J, Blackburn P, Evans R J, Hugenholtz J. Applications of the bacteriocin, nisin. Antonie Van Leeuwenhoek. 1996 Feb. 1;69(2):193-202.

Froseth B R, McKayY L L. Molecular characterization of the nisin resistance region of Lactococcus lactis subsp. lactis biovar diacetylactis DRC3. Applied and environmental microbiology. 1991 Mar. 1;57(3):804-11.

Gross E, Morell J L. Structure of nisin. Journal of the American Chemical Society. 1971 September;93(18):4634-5.

Hammami R, Zouhir A, Le Lay C, Hamida J B, Fliss I. BACTIBASE second release: a database and tool platform for bacteriocin characterization. Bmc Microbiology. 2010 December;10(1):22.

Hasper H E, de Kruijff B, Breukink E. Assembly and stability of nisin-lipid II pores. Biochemistry. 2004 Sep. 14;43(36):11567-75.

Khosa S, AlKhatib Z, Smits S H. NSR from Streptococcus agalactiae confers resistance against nisin and is encoded by a conserved nsr operon. Biological chemistry. 2013 Nov. 1;394(11):1543-9.

Khosa S, Frieg B, Mulnaes D, Kleinschrodt D, Hoeppner A, Gohlke H, Smits S H. Structural basis of lantibiotic recognition by the nisin resistance protein from Streptococcus agalactiae. Scientific reports. 2016 Jan. 4;6:18679.

Kuipers O P, de Ruyter P G, Kleerebezem M, de Vos W M. Quorum sensing-controlled gene expression in lactic acid bacteria. Journal of Biotechnology. 1998 Sep. 17;64(1):15-21.

O'Connor P M, O'Shea E F, Guinane C M, O'Sullivan O, Cotter P D, Ross R P, Hill C. Nisin H is a new nisin variant produced by the gut-derived strain Streptococcus hyointestinalis DPC6484. Applied and environmental microbiology. 2015 Apr. 3:AEM-00212.

Reiners J, Lagedroste M, Ehlen K, Leusch S, Zaschke-Kriesche J, Smits S H. The N-terminal region of nisin is important for the BceAB-Type ABC Transporter NsrFP from Streptococcus agalactiae COH1. Frontiers in microbiology. 2017 Aug. 29;8:1643.

Stein T, Heinzmann S, Solovieva I, Entian K D. Function of Lactococcus lactis nisin immunity genes nisI and nisFEG after coordinated expression in the surrogate host Bacillus subtilis. Journal of Biological Chemistry. 2003 Jan. 3;278(1):89-94.

Sun Z, Zhong J, Liang X, Liu J, Chen X, Huan L. Novel mechanism for nisin resistance via proteolytic degradation of nisin by the nisin resistance protein NSR. Antimicrobial agents and chemotherapy. 2009 May 1;53(5):1964-73.

Yoneyama F, Fukao M, Zendo T, Nakayama J, Sonomoto K. Biosynthetic characterization and biochemical features of the third natural nisin variant, nisin Q, produced by Lactococcus lactis 61-14. Journal of applied microbiology. 2008 December;105(6):1982-90.

Zendo T, Fukao M, Ueda K, Higuchi T, Nakayama J, Sonomoto K. Identification of the lantibiotic nisin Q, a new natural nisin variant produced by Lactococcus lactis 61-14 isolated from a river in Japan. Bioscience, biotechnology, and biochemistry. 2003 Jan. 1;67(7):1616-9.

1-15. (canceled)

16. A composition comprising:
(i) a nisin-producing strain of Lactococcus, and
(ii) a non-nisin degrading strain of Lactococcus that is a nisin-immune strain of Lactococcus, wherein the nisin-producing strain of Lactococcus and the non-nisin degrading strain of Lactococcus are different from each other.

17. The composition according to claim 16, wherein the nisin-producing strain of Lactococcus comprises a sequence having at least 95% sequence identity with a sequence selected from SEQ ID NO:1, SEQ ID NO:2, and SEQ ID NO:3.

18. The composition according to claim 16, wherein the nisin-producing strain of Lactococcus produces at least 0.1 mg nisin/kg cheese.

19. The composition according to claim 16, wherein one or more of the nisin-producing strain of Lactococcus and the non-nisin degrading, nisin-immune strain of Lactococcus are of a species selected from Lactococcus lactis subsp. lactis, Lactococcus lactis subsp. lactis biovar diacetylactis, and Lactococcus lactis subsp. cremoris.

20. The composition according to claim 16, wherein the non-nisin degrading, nisin-immune strain of Lactococcus is free of one or both of (i) a sequence having at least 90% sequence identity with SEQ ID NO:7 and (ii) a sequence having at least 90% sequence identity with SEQ ID NO:8.

21. The composition according to claim 16, wherein the non-nisin degrading, nisin-immune strain of Lactococcus comprises a sequence having at least 95% sequence identity with one or more sequences selected from SEQ ID NO:4 and SEQ ID NO:5.

22. The composition according to claim 21, wherein the non-nisin degrading, nisin-immune strain of Lactococcus is free of one or both of (i) a sequence having at least 90% sequence identity with SEQ ID NO:7 and (ii) a sequence having at least 90% sequence identity with SEQ ID NO:8.

23. The composition according to claim 21, wherein the non-nisin degrading, nisin-immune strain of Lactococcus comprises a sequence having at least 95% sequence identity SEQ ID NO:4 and a sequence having at least 95% sequence identity SEQ ID NO:5.

24. The composition according to claim 16, further comprising a non-nisin degrading strain of Lactococcus that is a non-nisin immune strain of Lactococcus.

25. The composition according to claim 24, wherein the non-nisin degrading, non-nisin-immune strain of Lactococcus is of a species selected from Lactococcus lactis subsp. lactis, Lactococcus lactis subsp. lactis biovar diacetylactis, and Lactococcus lactis subsp. cremoris.

26. The composition according to claim 24, wherein non-nisin degrading, non-nisin immune strain of Lactococcus is free of one or both of (i) a sequence having at least 90% sequence identity with SEQ ID NO:7 and (ii) a sequence having at least 90% sequence identity with SEQ ID NO:8, and:
(a) is free of a sequence having at least 90% sequence identity with SEQ ID NO:4,
(b) is free of a sequence having at least 90% sequence identity with SEQ ID NO:5, or (6) is free of a sequence having at least 90% sequence identity with SEQ ID NO:4 and is free of a sequence having at least 90% sequence identity with SEQ ID NO:5.

27. The composition according to claim 16, further comprising nisin.

28. The composition of claim 27, wherein the nisin is one or more selected from nisin A and nisin Z.

29. The composition according to claim 16, wherein the composition is a cheese and comprises at least 0.1 mg nisin/kg cheese.

30. The composition according to claim 16, wherein the composition is in a form selected from a liquid composition and a powder composition.

31. The composition according to claim 16, wherein the composition is in a form selected from a freeze-dried powder composition and a spray dried powder composition.

32. A method for acidifying milk, comprising:
(a) adding a composition according to claim 16 to milk to be acidified; and
(b) initiating acidification of the milk;
wherein the milk reaches a pH below 5.5 within 1-12 hours after step (a).

33. The method according to claim 32, wherein the milk reaches a pH below 5.5 within 1-6 hours after step (a).

34. The method according to claim 32, wherein the milk reaches a pH below 5.5 within 10 hours after step (a).

35. Cheese obtained by the method according to claim 32.


SEQUENCE LISTING (8 sequences)

SEQ ID NO: 1 - DNA, 105 bp, Lactococcus lactis
  >SEQ ID NO 1
attacaagtatttcgctatgtacacccggttgtaaaacaggagctctgatgggttgtaacatgaaaacagcaacttgtcattgtagtattcacgtaagcaaataa

SEQ ID NO: 2 - DNA, 105 bp, Lactococcus lactis
  >SEQ ID NO 2
attacaagtatttcgctatgtacacccggttgtaaaacaggagctctgatgggttgtaacatgaaaacagcaacttgtaattgtagtattcacgtaagcaaataa

SEQ ID NO: 3 - DNA, 105 bp, Lactococcus lactis
  >SEQ ID NO 3
attaccagcatttcgctttgtacaccaggttgtaaaacaggtgttctgatgggatgtaacctgaaaacagcaacttgtaattgtagcgttcacgtaagcaaataa

SEQ ID NO: 4 - DNA, 738 bp, Lactococcus lactis
  >SEQ ID NO 4
atgagaagatatttaatacttattgtggccttaatagggataacaggtttatcagggtgttatcaaacaagtcataaaaaggtgaggtttgacgaaggaagttatactaattttatttatgataataaatcgtatttcgtaactgataaggagattcctcaggagaacgttaacaattccaaagtaaaattttataagctgttgattgttgacatgaaaagtgagaaacttttatcaagtagcaacaaaaatagtgtgactttggtcttaaataatatttatgaggcttctgacaagtcgctatgtatgggtattaacgacagatactataagatacttccagaaagtgataagggggcggtcaaagctttgagattacaaaactttgatgtgacaagcgatatttctgatgataattttgttattgataaaaatgattcacgaaaaattgactatatgggaaatatttacagtatatcggacaccaccgtatctgatgaagaattgggagaatatcaggatgttttagctgaagtacgtgtgtttgattcagttagtggcaaaagtatcccgaggtctgaatgggggagaattgataaggatggttcaaattccaaacagagtaggacggaatgggattatggcgaaatccattctattagaggaaaatctcttactgaagcatttgccgttgagataaatgatgattttaagcttgcaacgaaggtaggaaactag

SEQ ID NO: 5 - DNA, 2039 bp, Lactococcus lactis
  >SEQ ID NO 5
atgcaggtaaaaattcaaaatctttctaaaacatataaagaaaagcaggtgctacaagatatcagttttgatattaaatctggaacagtctgtggtttattaggagttaacggtgcaggaaaatcaactttgatgaaaattttgtttggtttaatttctgcagatactggaaaaattttttttgatggacaagaaaagacaaataatcaacttggagccttaatcgaggctccagcaatatatatgaatttatctgctttcgataatcttaaaactaaggctttgctttttggaatttcagataagagaattcatgaaactctagaagtgattggtttggcagaaacaggaaagaaaagagcaggaaaattctctttagggatgaaacaacgtttgggaattggtatggctattcttacagaacctcaatttttaattcttgatgaacctactaatggtttggatcctgatggtattgcggagttgttaaacttaatcttaaaacttaaagctaaaggtgtgacaatcttgatttctagtcatcagttgcacgaaataagtaaagtagctagtcaaattattattttgaacaaaggtaagattcgttataatcatgcgaacaataaagaagacgacattgaacagttattctttaagattgtgcatggaggaatgtgatatgaaaagaataatagcatcagaagcaataaaattaaaaaaatcaggaactcttagattggtattaattatcccttttgtgactctatttatagcatttcttatgggtggaatacagatttttagtgttttttcaatttattggtgggaaactggttttttattccttttgatgagtttgctttttctttatgatataaaatcagaggagcaagctggaaattttcaaaatgtgaaatggaaaaagctgagttggaaaattcatttggccaaaatgttgttgatttggctaagaggtatactagcgagcatagtcttgattattttgctttatttggttgcttttgtgtttcaaggtattgtagtggtggattttatgaaagtaagtgtggcattgattgctatattactagcagcttcttggaatttaccctttatatacttgattttcaagtggattaatacttacgtattgttagctgcgaataccttgatttgtttaattgttgccccttttgttgcacaaactccagtatggttcttgctaccatacacttatcactataaagttacagaaagtttgttaaatatcaaaccatcaggagatttgttaacagggaagataaatttcagtatttgggaagttttattaccatttggactttccatagttgtaacgataggagtttcgtatttacttaaaggagtgatagaacatgataagaagtgaatgtctcaaattaaaaaatagcttagggttttatttagtttttctctttactttattagagcttttaacggttcctatttatttagcttttggaagaagtcatgtttcaatgactgatttatcgctcatgatttttttgttttttccgttactggttacaattttgtctattctaatctttgaacaggagagtctggccaatcgtttccaagaaataaatgtaaataaaaaaagtagcagaatttggttatcaaagctaatagtagtggatttccttttgttctttccatcagcaatgatctggataattacgggagtttcacaggcagtagggcaacaaggaatgatgatcgcaacagctagctggttgatggcaatttttcttaatcattttcatcttttattgacctttataatcaatcgaggagggagcatgattatcgcgattattgaaatattactcattatttttgccagtaataaagttttattagcagcttattggtgtcccattgctttacctgttaattttatgataactgggcggtgtgcttatctgatagctgccgtagggtggattgttttatccacaataattcttgtagcattatctaaaaaaaagattagataa

SEQ ID NO: 6 - DNA, 11014 bp, Lactococcus lactis
  >SEQ ID NO 6
ccaaatcaaaggatagtattttgttagttcagacatggatactatcctatttttataagttatttagggttgctaaatagcttataaaaataaagagaggaaaaaacatgataaaaagttcatttaaagctcaaccgtttttagtaagaaatacaattttatctccaaacgataaacggagttttactgaatatactcaagtcattgagactgtaagtaaaaataaagtttttttggaacagttactactagctaatcctaaactctatgatgttatgcagaaatataatgctggtctgttaaagaagaaaagggttaaaaaattatttgaatctatttacaagtattataagagaagttatttacgatcaactccatttggattatttagtgaaacttcaattggtgttttttcgaaaagttcacagtacaagttaatgggaaagactacaaagggtataagattggatactcagtggttgattcgcctagttcataaaatggaagtagatttctcaaaaaagttatcatttactagaaataatgcaaattataagtttggagatcgagtttttcaagtttataccataaatagtagtgagcttgaagaagtaaatattaaatatacgaatgtttatcaaattatttctgaattttgtgagaatgactatcaaaaatatgaagatatttgtgaaactgtaacgctttgctatggagacgaatatagagaactatcggaacaatatcttggcagtctgatagttaatcattatttgatctctaatttacaaaaagatttgttgtcagatttttcttggaacacttttttgactaaagttgaagcaatagatgaagataaaaaatatataattcctctgaaaaaagttcaaaagtttattcaagaatactcagaaatagaaattggtgaaggtattgagaaactgaaagaaatatatcaggaaatgtcacaaattcttgagaatgataattatattcaaattgatttaattagtgatagtgaaataaattttgatgttaaacaaaagcaacaattagaacatttagctgagtttttaggaaatacgacaaaatctgtaagaagaacatatttggatgactataaggataaatttatcgaaaaatatggtgtagatcaagaagtacaaataacagaattatttgattctacatttggcataggagctccatataattataatcatcctcgaaatgacttttatgagtccgaaccgagtactctatactattcagaagaggagagagaaaagtacctcagcatgtatgtagaagccgttaaaaatcataatgtaattaatcttgacgacttagagtctcattatcaaaaaatggacttagaaaagaaaagtgaacttcaagggttagaattatttttgaatttggcaaaggagtatgaaaaagatatttttattttaggggatatcgttggaaataataatttgggaggggcatcaggtagattttctgcactctctccggagttaacaagttatcatagaacgatagtagattctgtcgaaagagaaaatgagaataaagaaattacatcgtgtgaaatagtatttcttccagaaaatatcagacatgctaacgttatgcatacatcaattatgaggaggaaagtacttccattttttacaagtacaagtcacaatgaagttctgttaactaatatctatattggaatagacgaaaaagaaaaattttatgcacgagacatttcaactcaagaggtattgaaattctacattacaagcatgtacaataaaacgttattcagtaatgagctaagatttctttacgaaatttcattagatgacaagtttggtaatttaccttgggaacttatttacagagactttgattatattccacgtttagtatttgacgaaatagtaatatctcctgctaaatggaaaatttggggaagggatgtaaatagtaagatgacaataagagaacttattcaaagcaaagaaattcccaaagagttttatattgtcaatggagataataaagtttatttatcacaggaaaacccattggatatggaaattttagagtcggcgataaagaagagctcaaaaagaaaagattttatagagctacaagaatattttgaagatgaaaatatcataaataaaggagaaaaggggagagttgccgatgttgtagtgccttttattagaacgagagcattaggtaatgaagggagagcatttataagagagaaaagagtttcggttgaacggcgtgaaaaattgccctttaacgagtggctttatctaaagttgtacatttctataaatcgtcaaaatgaatttttactgtcgtatcttccagatattcagaaaatagtagcaaacctgggtggaaatctattcttcctaagatatactgatcctaaaccacatattagattgcgtataaaatgttcagatttatttttagcttacggatctattcttgaaatcttaaaaaggagtcggaaaaataggataatgtcaacttttgatatttctatttatgatcaagaagtagaaagatatggtggatttgatactttagagttatccgaagcaatattttgtgccgattctaaaattattccaaatttgcttacattgataaaagatactaataatgattggaaagtcgatgatgtatcaatcttggtgaattatttatatctgaaatgcttctttgagaatgataacaaaaagattcttaattttttgaatttagttagtcctaaaaaggttaaagaaaatgtcaatgaaaagattgaacattatcttaagcttctgaaagttaataatctaggtgaccaaattttttatgacaagaattttaaagaattaaagcatgccataaaaaatttatttttaaaaatgatagctcaagattttgaacttcagaaagtttattcaattattgacagtatcattcatgtccataataaccgactaattggtattgaacgagataaagagaaattaatttattacacacttcaaaggttgtttgtttcggaagaatacatgaaatgaggactaatagatggatgaagtgaaagaattcacatcaaaacaattttttaatactttacttactcttccaagcaccttgaagttaatttttcagttggaaaaacgttatgcaatttatttaattgtgctaaatgctatcacagcttttgttccgttggctagtctttttatttatcaagatttaataaactctgtgctaggttcagggagacatcttatcaatattattatcatctattttattgttcaagtgataacaacagttctgggacagctggaaagttatgttagtggaaaatttgatatgcgactttcttacagtatcaatatgcgcctcatgaggactacctcatctcttgaattaagtgattatgagcaggctgatatgtataatatcatagaaaaagttactcaagacagcacttacaagccttttcagctatttaatgctatcattgttgtgctttcatcgtttatctcattgttatctagtctattttttattggaacatggaacattggggtagcaattttactccttattgttccagtattatctttggtactttttctcagagtgggacaattagagtttttaatccagtggcagagagcaagttctgaaagagaaacatggtatattgtatatttattgactcatgatttttcatttaaagaaatcaagttaaataatattagcaattacttcattcataaatttggaaaattaaagaaaggatttatcaaccaagatttagctattgctcgtaagaagacatatttcaatatttttcttgatttcattttgaatttgataaatattcttacgatatttgctatgatcctttcggtaagagcaggaaaacttcttataggtaatttggtaagtctcatacaagctatttctaaaatcaatacttattctcaaacaatgattcaaaatatttacatcatttataatactagtttgtttatggaacaactttttgagtttttaaagagagaaagtgtagttcacaaaaaaatagaagatactgaaatatgcaatcaacatataggaactgttaaagtaattaatttatcatatgtttaccctaattcgaatgcctttgcactaaagaatatcaatttatcctttgaaaaaggagaattaactgctattgtaggaaaaaatggttcagggaaaagtacactagtaaagataatttcaggattatatcaaccaactatgggaataatccaatacgacaaaatgagaagtagtttgatgcctgaggagttttatcagaaaaacatatcggtgctgttccaagattttgtgaagtatgagttaacgataagagagaatataggattgagtgatttgtcttctcaatgggaagatgagaaaattattaaagtactagataatttaggactcgattttttgaaaactaataatcaatatgtacttgatacgcagttaggaaattggtttcaagaagggcatcaactttcaggaggtcagtggcaaaaaattgcattagcaaggacattctttaagaaagcttcaatttatattttagatgaaccaagtgctgcactcgatcctgtagctgaaaaagaaatatttgattattttgttgctctttcggaaaataatatttcaattttcatttctcatagtttgaatgctgccagaaaagcaaataaaatcgtggttatgaaagatggacaggtcgaagatgttggaagtcatgatgtccttctgagaagatgtcaatactatcaagaactttattattcagagcaatatgaggataatgatgaataaaaaaaatataaaaagaaatgttgaaaaaattattgctcaatgggatgagagaactagaaaaaataaagaaaacttcgatttcggagagttgactctctctacaggattgcctggtataattttaatgttagcggagttaaaaaataaagataactcaaagatatatcagaaaaagatagacaattatattgaatatattgttagcaaactttcaacatatgggcttttaacaggatcactttattcgggagcagctggcattgcattaagtatcctacatttacgagaagatgacgaaaaatataagaatcttcttgatagcctaaatagatatatcgaatatttcgtcagagaaaaaattgaaggatttaatttggaaaacattactcctcctgattatgacgtgattgaaggtttatctgggatactttcctatctattattaatcaacgacgagcaatatgatgatttgaaaatactcattatcaattttttatcaaatctgactaaagaaaacaaaggactaatatcgctttacatcaaatcggagaatcagatgtctcaatcagaaagtgagatgtatccactaggctgtttgaatatgggattagcacatggacttgctggagtgggctgtatcttagcttatgcccacataaaaggatatagtaatgaagcctcgttgtcagctttgcaaaaaattatttttatttatgaaaagtttgaacttgaaaggaaaaaacagtttctatggaaagatggacttgtagcagatgaattaaaaaaagagaaagtaattagggaagcaagtttcattagagatgcatggtgctatggaggtccaggtattagtctgctatacttatacggaggattagcactggataatgactattttgtagataaagcagaaaaaatattagagtcagctatgcaaaggaaacttggtattgattcatatatgatttgccatggctattctggtttaatagaaatttgttctttatttaagcggctattaaatacaaaaaagtttgattcatacatggaagaatttaatgttaatagtgagcaaattcttgaagaatacggagatgaaagtggcacgggttttcttgaaggaataagtggctgtatactggtattatcgaaatttgaatattcaatcaattttacttattggagacaagcactgttactttttgacgattttttgaaaggagggaagaggaaatgagaagatatttaatacttattgtggccttaatagggataacaggtttatcagggtgttatcaaacaagtcataaaaaggtgaggtttgacgaaggaagttatactaattttatttatgataataaatcgtatttcgtaactgataaggagattcctcaggagaacgttaacaattccaaagtaaaattttataagctgttgattgttgacatgaaaagtgagaaacttttatcaagtagcaacaaaaatagtgtgactttggtcttaaataatatttatgaggcttctgacaagtcgctatgtatgggtattaacgacagatactataagatacttccagaaagtgataagggggcggtcaaagctttgagattacaaaactttgatgtgacaagcgatatttctgatgataattttgttattgataaaaatgattcacgaaaaattgactatatgggaaatatttacagtatatcggacaccaccgtatctgatgaagaattgggagaatatcaggatgttttagctgaagtacgtgtgtttgattcagttagtggcaaaagtatcccgaggtctgaatgggggagaattgataaggatggttcaaattccaaacagagtaggacggaatgggattatggcgaaatccattctattagaggaaaatctcttactgaagcatttgccgttgagataaatgatgattttaagcttgcaacgaaggtaggaaactagagtgaaaaaaatactaggtttcctttttatcgtttgttcgttgggtttatcagcaactgtgcatggggagacaacaaattcacaacagttactctcaaataatattaatacggaattaattaatcataattctaatgcaattttatcttcaacagagggatcaacgactgattcgattaatctaggggcgcagtcacctgcagtaaaatcgacaacaaggactgaattggatgtaactggtgctgctaaaactttattacagacatcagctgttcaaaaagaaatgaaagtttcgttgcaagaaactcaagttagttctgaattcagtaagagagatagcgttacaaataaagaagcagttccagtatctaaggatgagctacttgagcaaagtgaagtagtcgtttcaacatcatcgattcaaaaaaataaaatcctcgataataagaagaatagagctaacttcgttacttcctctccgcttattaaggaaaaaccatcaaattctaaagatgcatctggtgtaattgataattctgcttctcctctatcttatcgtaaagctaaggaagtggtatctcttagacaacctttaaaaaatcaaaaagtagaggcacaacctctattgataagtaattcttctgaaaagaaagcaagtgtttatacaaattcacatgatttttgggattatcagtgggatatgaaatatgtgacaaataatggagaaagctatgcgctctaccagccctcaaagaaaatttctgttggaattattgattcaggaatcatggaagaacatcctgatttgtcaaatagtttaggaaattattttaaaaatcttgttcctaagggagggtttgataatgaagaacctgatgaaactggaaatccaagtgatattgtcgacaaaatgggacacgggacggaagtcgcaggtcagattacagcaaatggtaatattttaggagtagcaccagggattactgtaaatatatacagagtatttggtgaaaatctttcgaaatcggaatgggtagctagagcaataagaagagctgcggatgatgggaacaaggtcatcaatataagtgctggacagtatcttatgatttcaggatcgtatgatgatggaacaaatgattatcaagagtatcttaattataagtcagcaataaattatgcaacagcaaaaggaagtattgttgtcgcagctcttggtaatgatagtttaaacatacaagataaccaaacaatgataaactttcttaagcgtttcagaagtataaaggttcctggaaaagttgtagatgcaccgagtgtatttgaggatgtaatagccgtaggtggaatagatggttatggtaatatttctgattttagtaatattggagcggatgcaatttatgctcctgctggcacaacggccaattttaaaaaatatgggcaagataaatttgtcagtcagggttattatttgaaagattggctttttacaactactaatactggctggtaccaatatgtttatggcaactcatttgctactcctaaagtatctggggcactggcattagtagttgataaatatggaataaagaatcctaaccaactaaaaaggtttcttctaatgaattctccagaagttaatgggaatagagtattgaatattgttgatttattgaatgggaaaaataaagcttttagcttagatacagataaaggtcaggatgatgctattaaccataaatcgatggagaatcttaaagagtctagggatacaatgaaacaggaacaagataaagaaattcaaagaaatacaaataacaatttttctatcaaaaatgattttcataacatttcaaaagaagtaatttcagttgattataatattaatcaaaaaatggctaataatcgaaattcgagaggtgctgtttctgtacgaagtcaagaaattttacctgttactggagatggagaagattttttaccggctttaggtatagtgtgtatctcaatccttggtatattgaaaagaaagactaaaaattgatagattatatttcttcagaatgaatggtataatgaagtaatgagtactaaacaatcggaggtaaagtggtgtataaaattttaatagttgatgatgatcaggaaattttaaaattaatgaagacagcattagaaatgagaaactatgaagttgcgatgcatcaaaacatttcacttcccttggatattactgattttcagggatttgatttgattttgttagatatcatgatgtcaaatattgaagggacagaaatttgtaaaaggattcgcagagaaatatcaactccaattatctttgttagtgcgaaagatacagaagaggatattataaacggcttaggtattggtggggatgactatattactaagccttttagccttaaacagttggttgcaaaagtggaagcaaatataaagcgagaggaacgcaataaacatgcagttcatgttttttcagagattcgtagagatttaggaccaattacattttatttagaagaaaggcgagtctgtgtcaatggtcaaacaattccactgacttgtcgtgaatacgatattcttgaattactatcacaacgaacttctaaagtttatacgagagaggatatttatgatgacgtatatgatgaatattctaatgcactttttcggtcaatctcggaatatatttatcagattaggagtaagtttgcaccatacgatattaatccgataaaaacggttcggggacttgggtatcagtggcatgggtaaaaaatattcaatgcgtcgacggatatggcaagctgtcattgaaattatcataggtacttgtctacttatcctgttgttactgggcttgactttctttctacgacaaattggacaaatcagtggttcagaaactattcgtttatctttagattcagataatttaactatttctgatatcgaacgtgatatgaaacactacccatatgattatattatttttgacaatgatacaagtaaaattttgggaggacattatgtcaagtcggatgtacctagttttgtagcttcaaaacagtcttcacataatattacagaaggagaaattacttatacttattcaagcaataagcatttttcagttgttttaagacaaaacagtatgcctgaatttacaaatcatacgcttcgttcaatttcttataatcaatttacttaccttttcttttttcttggtgaaataatactcattattttttctgtctatcatctcattagagaattttctaagaattttcaagccgttcaaaagattgcattgaagatgggggaaataactacttttcctgaacaagaggaatcaaaaattattgaatttgatcaggttctgaataacttatattcgaaaagtaaggagttagctttccttattgaagcggagcgtcatgaaaaacatgatttatccttccaggttgctgcactttcacatgatgttaagacacctttaacagtattaaaaggaaatattgaactgctagagatgactgaagtaaatgaacaacaagctgattttattgagtcaatgaaaaatagtttgactgtttttgacaagtattttaacacaatgattagttatacaaaacttttgaatgatgaaaatgattacaaagcgacaatctccctggaggattttttgatagatttatcagttgagttggaagagttgtcaacaacttatcaagtggattatcagctagttaaaaaaacagatttaaccactttttacggaaatacattagctttaagtcgagcacttatcaatatctttgttaatgcctgtcagtatgctaaagagggtgaaaaaatagtcagtttgagtatttatgatgatgaaaaatatctctattttgaaatctggaataatggtcatcctttttctgaacaagcaaaaaaaaatgctggaaaactatttttcacagaagatactggacgtagtgggaaacactatgggattggactatcttttgctcaaggtgtagctttaaaacatcaaggaaacttaattctcagtaatcctcaaaaaggtggggcagaagttatcctaaaaataaaaaagtaa

SEQ ID NO: 7 - DNA, 213 bp, Lactococcus lactis
  >SEQ ID NO 7
gtgctccatagaaaaaatggttctgattcagcaggttatacttctgctaatcaaaccgtctatttatatgatggctcaacattacaaataacttctgcttttgtaaaagacagaacaaataatatttataaaaattttcctattagtccggacattcaaacaaataatgctaaaagttctgcaatagaatggataaaatctcaaataaagtaa

SEQ ID NO: 8 - DNA, 957 bp, Lactococcus lactis
  >SEQ ID NO 8
atgaaaataggtaagcgcattttattaggtctagtggcagtatgtgctttatttttaggaattatctatctttgggggtataaattcaacatatatttagtaccaccctcccctcagaagtatgttcgagttgccttaaaaaatatggatgaacttgggctatttactgattcaaaagaatgggtagaaactaaaaaaaagacgatagaagaaacatcaaatgctaaaaactatgcagaaacaatcccttttttacaaaaagcgattaaagttgcaggaggaaagcattcttttattgaacatgaagaagacatatcaaaaagaagcatgacaaaatatataaaaccaaaggcagaaatcgaaggcaacactttaatattaactattcctgaatttactggaaatgatagtcaagcatctgattacgctaattttttagaatcttcattgcataaaaacaattataatggggtaattgttgatttgagggggaatagaggtggagacttatctcctatggtattaggattatcccccctattgcctgatggaactctatttacttatgttgataaaagtagtcattctaaacctgttgaactacaaaatggagaaataaatagtggcgggtcatcaacaaaaataagtgataataaaaaaattaaaaaagctcctattgctgtattaatagataataatacagggagctccggcgaattaaccgctttgtgctttgagggaatacctaatgttaaatttttgggttctgattcagcaggttatacttctgctaatcaaaccgtctatttatatgatggctcaacattacaaataacttctgcttttgtaaaagacagaacaaataatatttataaaaattttcctattagtccggacattcaaacaaataatgctaaaagttctgcaatagaatggataaaatctcaaataaagtaa